(19) United States
(12) Patent Application Publication
(10) Pub. No.: US 2014/0370763 A1
(43) Pub. Date: Dec. 18, 2014

(54) CONNECTION OF A FIRST METAL COMPONENT TO A COVERED SECOND METAL COMPONENT

(71) Applicant: Daniel Bechstein, Brackenheim (DE)

(72) Inventor: Daniel Bechstein, Brackenheim (DE)

(73) Assignee: KROMBERG & SCHUBERT KG, Wuppertal (DE)

(21) Appl. No.: 14/358,240

(22) PCT Filed: Feb. 6, 2013
(86) PCT No.: PCT/EP2013/052271

§ 371 Date: May 15, 2014

(30) Foreign Application Priority Data
Feb. 26, 2012 (DE) 102012003537.3
Apr. 18, 2012 (DE) 102012007870.6

(51) Int. Cl. H01R 24/28; H01R 43/02; H01R 43/00

(52) U.S. Cl. CPC H01R 24/28; H01R 43/005; H01R 43/02
USPC 439/887; 29/879

(57) ABSTRACT

The invention relates to a connection between a first metal component and a second metal component covered by a sheath. The first and the second metal component are connected to one another by means of a welded connection. In each case, a partial region of the first metal component and a partial region of the second metal component that comprises at least one section of the sheath are enclosed by a layer of insulating material that is applied.

### PRIOR ART

The invention relates to a connection of a first metal component to a covered second metal component in accordance with the preamble to claim 1. The invention furthermore relates to a method for producing a connection of this type, as defined in the preamble to claim X. The first metal component can be a copper component, for example, while the second metal component can be an aluminum component. For reasons of cost reduction and to save weight, aluminum cables are increasingly used in the field of automotive manufacturing. The cable ends are generally provided with lugs made of copper or other metals which permit a fastening of the cables. When used in motor vehicles, cables of this type are subjected to extreme stresses, for example, in particular to temperature changes, vibration stresses and the effects of moisture.

If moisture is allowed to reach the connection between the aforementioned components, which is usually produced by welding, a rapid corrosion of the aluminum must be feared which has a negative effect on the cable strength and thus the operational safety of the complete onboard power supply.

To be sure, attempts have previously been made to seal the connecting location between the components against moisture by using shrink-wrap hose and/or by using shrink-wrap hose/butyl strip seals and/or through insert-molding with polymers. These known sealing systems, however, cannot be used in practical operations for the temperature range of approximately −40° C. to approximately +230° C. and will therefore fail. Furthermore detrimental for a good sealing effect are the widely varying expansion coefficients of the materials used.

A method for covering micro-electric hybrid semiconductor circuits or micro-electronic semiconductor components is known from the DE 34 42 131 A1. With said method, the components located on a substrate are covered by pouring a soft, sealing layer of plastic over them, covering this layer with a compound foil of plastic and metal, and subsequently encapsulating it with synthetic resin. With this relatively involved method, a low-viscous, liquid elastomer is applied, for example, to form the soft sealing layer of synthetic material. A composite foil of plastic and metal is then placed onto this layer and is pressed against it with a hollow punch. A synthetic resin, especially a highly filled epoxy casting resin, is then used for the insert-molding or encapsulation.

A method for covering electric and electronic components or assemblies is known from the EP 0 361 194 A2, for which an intermediate layer of an elastic synthetic material is initially applied to the mechanically sensitive regions, which are then covered with an outer cover layer of a mechanically and chemically stable synthetic material. In the process, the outer covering layer as well as the intermediate layer are produced through injection-molding with molding compound in an injection molding tool. During the injection molding process, however, components to be encapsulated are subjected to relatively high pressure and temperature stresses.

The DE 10 2004 062 457 A1 discloses a water-absorbing composition with suppressed corrosiveness when in the swollen state, relative to copper, wherein its use is known for cable sheaths and for a sheathed cables.

It is the object of the invention to provide an improved connection between components made of different metals.

This object is solved with the invention as disclosed in claim 1.

An advantageous method for producing such a connection is disclosed in claim x.

### ADVANTAGES OF THE INVENTION

Extensive testing during practical operations has shown that the connection embodied according to the invention can withstand stresses caused by temperature changes in a temperature range between approximately −40° C. and +190° C., with strong mechanical vibration stress and high moisture over long periods of time. Even after subjecting the connection for many hours to a continuous temperature of 180° C. and temperature peaks of approximately up to 230° C., no failure of the connection could be detected. It can therefore be expected that when using the connection designed according to the invention, the operational safety can clearly be improved.

Additional advantages follow from the dependent claims, the description and the drawing.

### DRAWING

An exemplary embodiment of the invention is explained in further detail in the following, with reference to the drawing.

Shown are in:

FIG. 1—a view from above of a manufactured cable;

FIG. 2—a view from the side of a manufactured cable;

FIG. 3—a longitudinal section through the cable shown in FIG. 1;

FIG. 4—a cross section through the cable shown in FIG. 1.

### DESCRIPTION OF AN EXEMPLARY EMBODIMENT

The connection according to the invention is explained in the following with reference to the drawing and an exemplary embodiment in the form of a cable manufactured with a cable lug.

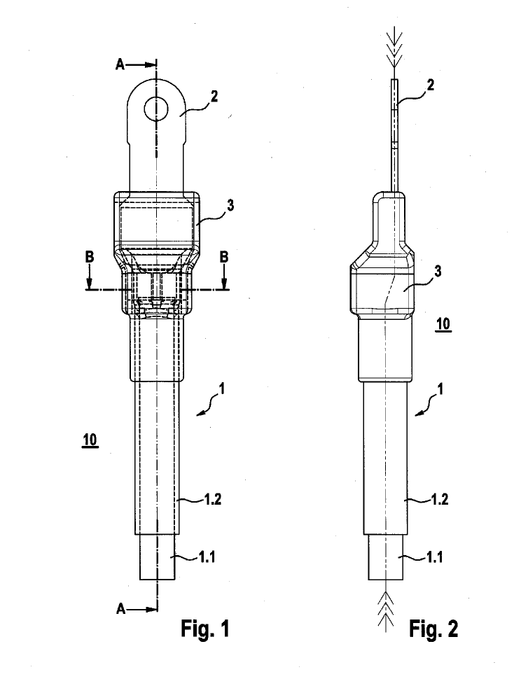

FIG. 1 shows a view from above of the cable 1 manufactured with a cable lug 2.

FIG. 2 shows a view from the side of the cable illustrated in FIG. 1. The first metal component in this case is the cable lug 2, preferably consisting of copper or a copper alloy, which is advantageously covered with a contact layer of NiP that is not shown in further detail in the drawing. The second metal component within the meaning of the invention is a cable 1, consisting of a conductor 1.1 of aluminum that is encased in a sheath 1.2. The metal components 1 and 2 are connected by a welded connection that is preferably produced through ultrasonic welding. The welding location is enclosed with a sheath of insulating material 3 which, in some sections, also encloses the sheath 1.2 of the cable 1 and the cable lug 2.

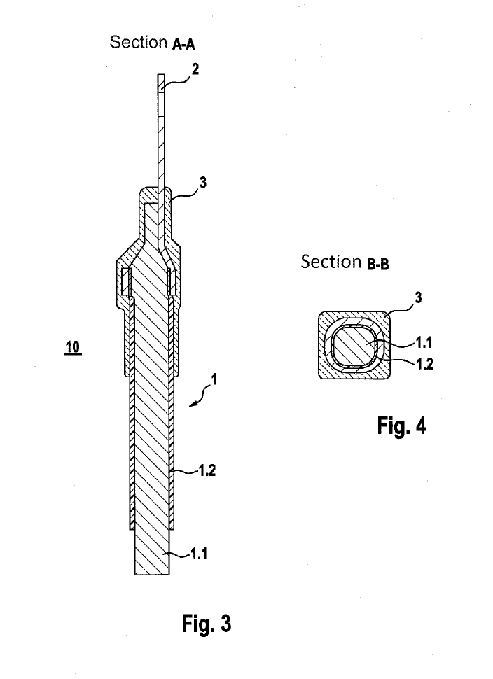

FIG. 3 shows a longitudinal section through the finished cable 1, illustrated in FIG. 1.

FIG. 4 shows a cross section through the finished cable 1, illustrated in FIG. 1.

An advantageous method for producing the connection according to the invention is described in the following with the aid of an example for producing a cable 1 with cable lug 2. The cable 1 is an aluminum cable that is sheathed with a sheath 1.2 of a polyorganosiloxane (htv silicone rubber)¹. The cable lug 2 consists of copper, which is covered with a contact layer of NiP², having a thickness of approximately 0.3 to 5 μm and, in particular, of 0.5 to 3 μm. In the connecting region, the conductor 1.1 of aluminum is exposed by removing the silicon sheath 1.2. The cable lug 2 and the aluminum cable 1 are preferably connected with the aid of ultrasonic welding. The silicon sheath 1.2 of the cable 1 is first cleaned with cellulose and isopropanol. This is followed by a surface activation of the cable 1 in the connecting region and the cable lug 2 in an insulated atmospheric plasma. The connecting region is then insert-molded in the connecting region with polyorganosiloxane (2k-LSR, liquid silicon rubber, 2 components), which is subsequently cross-linked at a temperature ranging from approximately 160° C. to approximately 210° C., in particular at a temperature ranging from approximately 170° C. to approximately 210° C. ¹ HTV=high temperature vulcanization² NiP=nickel phosphorous

Subsequent examinations of the connecting location have shown that the applied 2k silicon (LSR) has bonded with the 1k silicon (HTV) of the cable sheath, so as to advantageously form a permanent and durable, moisture resistant connection. An extraordinarily strong, moisture-resistant connection was also detected between the NiP layer of the cable lug and the applied 2k silicone following the cross-linkage.

1. A connection between a first metal component and a second metal component covered by a sheath, the first and the second metal component being joined by a welded connection and a partial region of the first metal component and a partial region of the second metal component, involving at least a section of the sheath, being covered by an applied insulating layer, a contact layer of NiP being applied to the first metal component, and the applied insulating layer being composed of polyorganosiloxane (LSR—liquid silicon rubber).

2. The connection of claim 1, wherein the insulating layer is insert-molded and is cross-linked by subjecting it to heat.

3. The connection of claim 1, wherein the first metal component is made of copper or a copper alloy.

4. (canceled)

5. The connection of claim 1, wherein the sheath for the second metal component is composed of a polyorganosiloxane (HTV silicon).

6. (canceled)

7. A method for producing a connection between a first metal component and a second metal component covered by a sheath, comprising:
covering the first metal component with a contact layer of NiP;
connecting an end piece of the second metal component, with some sections of its sheath exposed and with the aid of a welded connection, to the first metal component;
cleaning a partial region of the cable sheath, that is to be insert-molded later on with an insulating material, with isopropanol;
subjecting the connecting region, between the first and the second metal component, and the partial region of the cable sheath, to be insert-molded, to an insulated atmospheric plasma;
insert-molding the connecting region, and at least a partial region of the sheath around the cable, with an insulating material of a poly-organosiloxane (LSR=liquid silicon rubber); and
f) cross linking the insulating material through heating.

8. The connection of claim 3, wherein the second metal component is made of aluminum.

9. The connection of claim 1, wherein the contact layer of NiP has a thickness of approximately 0.3 to 5 μm.

10. The connection of claim 9, wherein the contact layer of NiP has a thickness of approximately 0.5 to 3 μm.

11. The connection of claim 2, wherein the first metal component is made of copper or a copper alloy.

12. The connection of claim 2, wherein the sheath for the second metal component is composed of a polyorganosiloxane (HTV silicon).

13. The connection of claim 2, wherein the contact layer of NiP has a thickness of approximately 0.3 to 5 μm.

14. The connection of claim 13, wherein the contact layer of NiP has a thickness of approximately 0.5 to 3 μm.
